(19) United States
(12) Patent Application Publication
(10) Pub. No.: US 2026/0185593 A1
(43) Pub. Date: Jul. 2, 2026

(54) WET-RUNNING BEVEL GEAR DIFFERENTIAL FOR AN ELECTRICALLY OPERABLE AXLE DRIVE TRAIN

(71) Applicant: SCHAEFFLER TECHNOLOGIES AG & CO. KG, Herzogenaurach (DE)

(72) Inventors: Jochen LOEFFELMANN, Eggolsheim (DE); Andreas Rosenwald, Nurnberg (DE)

(73) Assignee: SCHAEFFLER TECHNOLOGIES AG & CO. KG, Herzogenaurach (DE)

(21) Appl. No.: 18/840,961

(22) PCT Filed: Feb. 8, 2023
(86) PCT No.: PCT/DE2023/100098

§ 371 Date: Aug. 23, 2024

(30) Foreign Application Priority Data
Feb. 25, 2022 (DE) 10 2022 104 518.8

(51) Int. Cl. F16H 48/08; F16H 48/40; F16H 57/04

(52) U.S. Cl. CPC F16H 48/08; F16H 48/40; F16H 57/0428; F16H 57/0483

(57) ABSTRACT

A wet-running bevel gear differential for an electrically operable axle drive train of a motor vehicle having a first differential cage connected via a connecting region to a second differential cage for conjoint rotation therewith, and the two interconnected differential cages accommodate two output gears aligned with one another and both mesh with at least one compensating gear, wherein the two interconnected differential cages can be driven together so as to rotate about the axis of rotation of the aligned output gears. At least one of the differential cages is surrounded by a bell-shaped oil guide cap that is axially open on both sides and that has channels which are formed on its inner peripheral surface facing the differential cage and which can guide oil in the axial direction within the oil guide cap and thus in the intermediate space between the oil guide cap and the corresponding differential cage.

### CROSS-REFERENCE TO RELATED APPLICATIONS

This application is the U.S. National Phase of PCT Appln. No. PCT/DE2023/100098, filed Feb. 8, 2023, which claims the benefit of German Patent Appln. No. 102022104518.8, filed Feb. 25, 2022, the entire disclosures of which are incorporated by reference herein.

### TECHNICAL FIELD

The present disclosure relates to a wet-running bevel gear differential, in particular for an electrically operable axle drive train of a motor vehicle, wherein an oil feed is realized between the differential cage of the bevel gear differential and a further component.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, May 2011, pages 360-365 by Erik Schneider, Frank Fickl, Bernd Cebulski and Jens Liebold with the title: “Hochintegrativ und flexibel—Elektrische Antriebseinheit für E-Fahrzeuge” [Highly Integrative and Flexible—Electric Drive Unit for Electric Vehicles], which is probably the closest prior art. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

DE 10 2010 048 837 A1 discloses such a drive device having at least one electric motor and at least one planetary differential that can be driven by a rotor of the electric motor, wherein the planetary differential has at least one planetary carrier that is operatively connected to a rotor of the electric motor, first planetary gears and second planetary gears, which are rotatably mounted on the planetary carrier, and a first sun gear and a second sun gear, each of which is operatively connected to an output shaft of the planetary differential. The first planetary gears mesh with the first sun gear and each of the second planetary gears meshes with the second sun gear and with one of the first planetary gears. Furthermore, the sun gears are arranged coaxially with an axis of rotation of the rotor.

A bevel gear differential is further known from the publication EP 1 472 475 B1, which can also be used in e-axles, for example. The bevel gear differential comprises a differential housing, which can be driven via a ring gear firmly connected to the housing, as well as differential gears, which are rotatably mounted in the differential housing, and additionally two planetary gears, which are also rotatably mounted in the differential housing, with which the differential gears mesh and in this way form the outputs of the bevel gear differential.

### SUMMARY

In the development of electric machines and transmissions intended for e-axles, there is a continuing need to increase their power densities, so that the cooling required for this, in particular of the electric machines and transmissions, is becoming increasingly important. Owing to the necessary cooling capacities, hydraulic fluids such as cooling oils have become established in most concepts for the removal of heat from the thermally loaded regions of an electric machine and/or transmission.

It is the object of the disclosure to provide an improved wet-running bevel gear differential.

This object is achieved with a wet-running bevel gear differential, in particular for an electrically operable axle drive train of a motor vehicle, having a first differential cage which is connected via a connecting region to a second differential cage for conjoint rotation therewith, and wherein the two interconnected differential cages accommodate two output gears which are aligned with one another and both mesh with at least one differential gear, wherein the two interconnected differential cages can be driven together so as to rotate about the axis of rotation of the output gears which are aligned with one another, in that at least one of the two differential cages is surrounded by a bell-shaped oil guide cap that is axially open on both sides and that has channels which are formed on its inner peripheral surface facing the differential cage and which can guide oil in the axial direction within the oil guide cap and thus in the intermediate space between the oil guide cap and the corresponding differential cage.

The oil from the intermediate space of the oil guide cap and the differential cage enters into the inside of the differential cage at a point designated for this purpose. The oil guide cap guides the oil from, for example, a tapered roller bearing, which supports the differential cage relative to the transmission housing, to this point or points.

This has the advantage that the bevel gear differential and its accommodated gears are reliably supplied with oil. As a result, an improved lubrication or cooling of the bevel gear differential can be achieved even if the differential cage is almost closed and does not have any large openings on the differential cage in order to make it particularly dimensionally stable. Furthermore, the bevel gear differential is protected against external mechanical influences and contamination.

As the inside of the bevel gear differential is supplied with oil, the bevel gear differential is a wet-running bevel gear differential, which swirls the oil inside the differential cages during operation in such a way that the differential and output gears are sufficiently lubricated during operation.

Thus, according to the disclosure, a bevel gear differential is proposed which is suitable and/or designed for use in a vehicle. On the one hand, the bevel gear differential can be designed as a longitudinal differential, with which a drive torque can be distributed to two axles of the vehicle, or as a transverse differential or axle differential, wherein a drive torque is distributed to two output shafts of one and the same axle.

The bevel gear differential according to the disclosure can be used in particular in an electrically operable axle drive train of a motor vehicle. An electric axle drive train of a motor vehicle comprises an electric machine and a transmission arrangement. The transmission arrangement comprises the bevel gear differential according to the disclosure.

Provision can in particular be made for the electric machine and the transmission arrangement to be arranged in a common drive train housing. Alternatively, it would also be possible for the electric machine to have a motor housing and the transmission to have a transmission housing, wherein the structural unit can then be brought about by fixing the transmission arrangement in relation to the electric machine. This structural unit is also known as an e-axle or electrically operable axle drive train.

The transmission arrangement of the electric axle drive train can, in particular, be coupled to the electric machine, which is designed to generate a drive torque for the motor vehicle. The drive torque is a main drive torque, meaning that the vehicle is driven exclusively by the drive torque of the electric machine.

The at least one differential cage of the bevel gear differential is advantageously designed to be bell-shaped. Both differential cages can have the same bell-shaped design, wherein both differential cages can also be identical. The advantageous effect of this bell-shaped design is that it provides the differential cage with particularly good structural stability, which also means that the fluid can be guided through the channels in a particularly controlled manner in combination with the bell-shaped oil guide cap placed on the differential cage. The bell-shaped design of the oil guide cap is advantageously congruent to the bell-shaped differential cage, wherein the oil guide cap has a central opening at its two axial ends, with which, on the one hand, the oil guide cap can be plugged onto the differential cage and, on the other hand, the differential cage is not axially closed by the oil guide cap.

According to one embodiment of the disclosure, oil entering from one end of the oil guide cap via channel openings formed there by the oil guide cap can be guided into the differential cage surrounded by the oil guide cap with the aid of the channels.

Alternatively or in addition, the differential cage, which carries the oil guide cap, can also have channels extending in the axial direction on its outer circumferential surface, the channel openings of which face the tapered roller bearing in each case.

According to a further embodiment of the disclosure, the at least one differential cage is rotatably mounted at one end via a tapered roller bearing relative to a connection structure of the transmission housing, wherein in rotary operation of the bevel gear differential the oil is introduced in the axial direction into the channel openings of the oil guide cap by the conveying effect generated by the rotation of the tapered roller bearing.

It is advantageous that the channel openings (of the oil guide cap and/or the differential cage) are located on the circumference of the pitch circle diameter. In particular, this pitch circle diameter can be positioned with the pitch circle diameter of the tapered rollers of the tapered roller bearing, whereby a particularly good oil supply from the bearing into the oil guide cap can be achieved.

Furthermore, according to an equally advantageous embodiment of the disclosure, the oil guide cap can be connected for conjoint rotation to the differential cage at a connecting region with the differential cage surrounded by the oil guide cap. This means that there is no relative speed between the differential cage and the oil guide cap it carries.

According to a further embodiment of the disclosure, the connecting region can also comprise the connection for conjoint rotation of the two differential cages to one another. The connection for conjoint rotation of the two differential cages to one another is advantageous in that, prior to forming the connection, the gears arranged within the bevel gear differential can be pre-assembled and then the two differential cages can be connected to one another for conjoint rotation.

For the connection into the connecting region, the differential cage has a cylindrical ring-like attachment section extending coaxially to the axis of rotation of the differential cage.

In a further development of the disclosure, the oil guide cap is designed as a plastic injection-molded part. This allows the oil-guiding structures of the channels and channel openings to be produced in a simple and therefore economical manner.

In one embodiment, the channel openings widen the channels in a funnel-like manner in the circumferential direction. This allows oil to be efficiently captured in the channels when the oil guide cap rotates during operation.

In one embodiment of the disclosure, the channels of the oil guide cap are designed in a trough-like manner and thus form two axially extending and circumferentially opposite walls, wherein the channels also have an inner peripheral surface facing the axis of rotation for guiding the oil. Due to the centrifugal force acting on the oil during operation, the oil is placed on the inner peripheral surface, slides to the larger diameter end of the oil guide cap due to the bell-shaped design and is conveyed more quickly and accurately to the entry points of the differential cage, through which the oil reaches the gears, via the channels designed in a trough-like manner.

In one embodiment, the channels are delimited by the outer peripheral surface of the differential cage surrounded by the oil guide cap.

Finally, the object can be achieved by an electrically operable axle drive train of a motor vehicle, comprising an electric machine and the bevel gear differential according to the disclosure coupled to the electric machine.

### BRIEF DESCRIPTION OF THE DRAWINGS

The disclosure is explained in more detail below with reference to drawings without limiting the general concept of the disclosure.

In the drawings:

FIG. 1 shows an electrically operable axle drive train in a schematic axial sectional view,

FIG. 2 shows a drive gear with its differential cage in an exposed perspective view,

FIG. 3 shows an exposed differential cage in a perspective view, and

FIG. 4 shows a motor vehicle with an electrically operable axle drive train in a schematic block diagram view.

### DETAILED DESCRIPTION

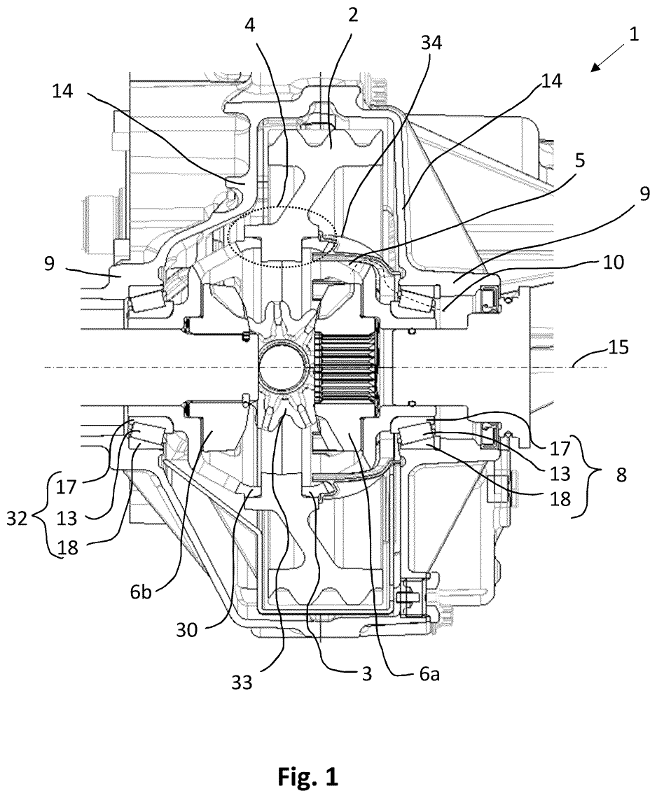

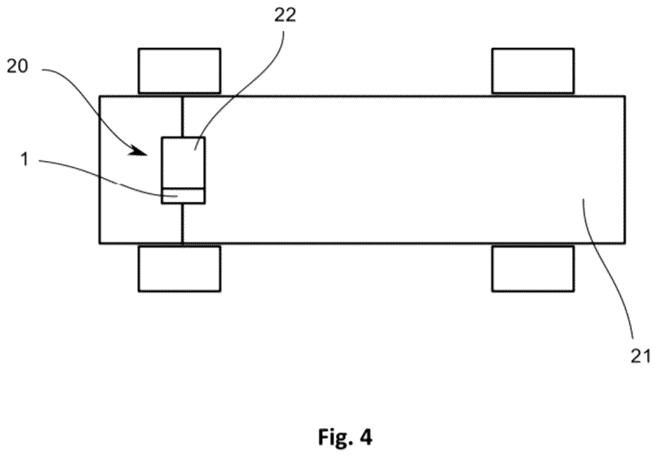

FIG. 1 shows a wet-running bevel gear differential 1 within an electrically operable axle drive train 20 of a motor vehicle 21, as also sketched in FIG. 4.

The bevel gear differential 1 has a drive gear 2 and a first and a second differential cage 3 and 30, wherein the differential cage 3 is connected for conjoint rotation to the drive gear 2 and to the differential cage 30 via a connecting region 4 (dotted line). Within the bevel gear differential 1, the known and meshing differential gears 33 (exactly one visible in this exemplary embodiment) and output gears 6a, 6b are arranged.

The differential cage 3 is rotatably mounted at an end 7 facing away from the drive gear 2 via a tapered roller bearing 8 relative to a connection structure 9 of the transmission housing 14. The oil guide cap 34 sits on the outside of the differential cage 3 and is connected to the differential cage 3 for conjoint rotation. An intermediate space exists between the oil guide cap 34 and the differential cage 3, which can guide oil in the axial direction. When the bevel gear differential 1 rotates during operation, the oil is conveyed in the axial direction from the tapered roller bearing 8 through the remaining intermediate space between the differential cage 3 and the oil guide cap 34 by the conveying effect generated by the rotation of the tapered roller bearing 8, which is indicated by the dashed arrows. The oil-guiding intermediate space between the oil guide cap 34 and the differential cage 3 is formed by channels 11 and channel openings 12, which can be seen more clearly in the following figures.

FIGS. 1 to 3 show an embodiment of the oil guide cap 34 according to the disclosure.

It can be seen from the synopsis of FIGS. 1 to 3 that the first bell-shaped oil guide cap 34 which is axially open on both sides has channels 11 extending through it in the axial direction, wherein each channel 11 has a channel opening 12 widening in a funnel-like manner, which faces the tapered roller bearing 8. The channel openings 12 are positioned approximately on the same pitch circle diameter as that of the tapered rollers 13 of the tapered roller bearing 8. The channels 11 open into openings in the differential cage 3 on the differential cage side so that the oil can reach the inside of the bevel gear differential 1. The bevel gear differential 1 is therefore a wet-running bevel gear differential.

The oil guide cap 34 engages in receptacles 5 of the differential cage 3, which in a further embodiment are advantageously designed such that the oil is guided from outside the differential cage 3 through these receptacles 5 into the interior of the differential cage 3 and thus into the interior of the bevel gear differential 1. The receptacles 5 can alternatively serve solely for fastening the oil guide cap 34 on the differential cage 3, wherein other openings can be provided for introducing the oil through the oil guide cap 34 on the differential cage 3 in accordance with the disclosure.

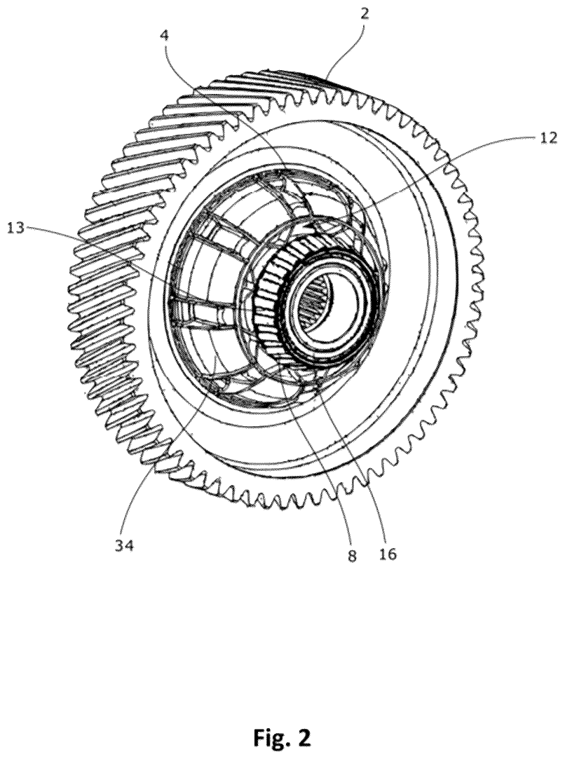

FIG. 2 shows a view of the oil guide cap 34, which sits on the differential cage 3. Also clearly visible are the channel openings 12, which are distributed around the circumference and can introduce oil escaping from the tapered roller bearing 8 into the channels 11 adjoining the channel openings 12.

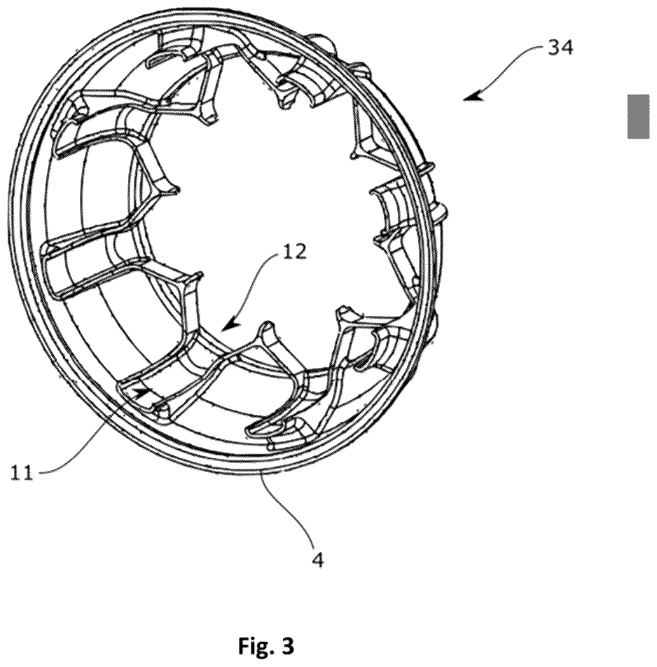

The illustration in FIG. 3 shows a view into the interior of the oil guide cap 34—from the perspective of the differential cage 3. The channels 11, which extend in the axial direction and are arranged distributed in a regular pattern around the circumference, are clearly visible. At the point indicated by the reference sign 11, the differential cage 3, not shown here, has the receptacles 5 required to accommodate the oil guide cap 34, which are present in the same number and order as the channels 11.

FIG. 3 also shows the end-face annular surface of the oil guide cap 34, which enters the connecting region 4 in order to ensure a defined axial contact between the oil guide cap 34 and the differential cage 3.

The differential cage 3 has a cylindrical ring-like attachment section 16 extending coaxially to the axis of rotation 15 of the differential cage 3 for the connection of the inner ring 17 of the tapered roller bearing 8 for conjoint rotation, so that the tapered roller bearing 8 and the differential cage 3 can form a structural unit.

The bevel gear differential 1 is accommodated in a transmission housing 14 that is sealed in an oil-tight manner against its surroundings, so that the oil can be conducted through the transmission housing 14 or the bevel gear differential 1.

The shown bevel gear differential 1 further has a second differential cage 30, which is rotatably mounted at an end 31 facing away from the drive gear 2 via a second tapered roller bearing 32 relative to the connection structure 9 of the transmission housing 14.

FIG. 4 shows a preferred application of the wet-running bevel gear differential 1 in an electrically operable axle drive train 20 of a motor vehicle 21, comprising an electric machine 22 and the bevel gear differential 1 coupled to the electric machine 22.

### LIST OF REFERENCE SYMBOLS

1 Bevel gear differential
2 Drive gear
3 Differential cage
4 Connecting region
5 Receptacle
6a, 6b Output gear
7 End
8 Tapered roller bearing
9 Connection structure
10 Oil
11 Channels
12 Channel opening
13 Tapered rollers
14 Transmission housing
15 Axis of rotation
16 Attachment section
17 Inner ring
18 Outer ring
20 Axle drive train
21 Motor vehicle
22 Electric machine
30 Differential cage
31 End
32 Tapered roller bearing
33 Differential gear
34 Oil guide cap

1. A wet-running bevel gear differential for an electrically operable axle drive train of a motor vehicle, comprising:
a first differential cage which is connected via a connecting region to a second differential cage for conjoint rotation therewith, wherein the two interconnected differential cages accommodate two output gears which are aligned with one another and both mesh with at least one differential gear, wherein
the two interconnected differential cages can be driven together so as to rotate about the axis of rotation of the output gears which are aligned with one another, and
wherein
at least one of the differential cages is surrounded by a bell-shaped oil guide cap that is axially open on both sides and that has channels which are formed on its inner peripheral surface facing the at least one differential cage and which can guide oil in an axial direction within the oil guide cap in an intermediate space between the oil guide cap and the corresponding at least one differential cage.

2. The bevel gear differential according to claim 1,
wherein
oil entering from one end of the oil guide cap via channel openings formed there by the oil guide cap can be guided into the differential cage surrounded by the oil guide cap with the aid of the channels.

3. The bevel gear differential according to claim 1,
wherein
the at least one differential cage is rotatably mounted at one end via a tapered roller bearing relative to a connection structure of the transmission housing, wherein in rotary operation of the bevel gear differential the oil is introduced in the axial direction into the channel openings of the oil guide cap by the conveying effect generated by the rotation of the tapered roller bearing.

4. The bevel gear differential according to claim 1, wherein
the oil guide cap is connected for conjoint rotation to at least one of the differential cages at a connecting region with the at least one differential cage surrounded by the oil guide cap.

5. The bevel gear differential according to claim 1,
wherein
the connecting region also comprises a connection for conjoint rotation of the two differential cages to one another.

6. The bevel gear differential according to claim 1,
wherein
the oil guide cap is designed as a plastic injection-molded part.

7. The bevel gear differential according to claim 1,
wherein
the channel openings widen the channels in a funnel-like manner in a circumferential direction.

8. The bevel gear differential according to claim 1,
wherein
the channels of the oil guide cap are designed in a trough-like manner and have two axially extending and circumferentially opposite walls and an inner peripheral surface facing an axis of rotation for guiding the oil.

9. The bevel gear differential according to claim 1,
wherein
the channels are delimited by an outer peripheral surface of the at least one differential cage surrounded by the oil guide cap.

10. An electrically operable axle drive train of a motor vehicle, comprising an electric machine and a bevel gear differential coupled to the electric machine, the bevel gear differential comprising: a first differential cage which is connected via a connecting region to a second differential cage for conjoint rotation therewith, wherein the two interconnected differential cages accommodate two output gears which are aligned with one another and both mesh with at least one differential gear, wherein the two interconnected differential cages can be driven together so as to rotate about the axis of rotation of the output gears which are aligned with one another, wherein
at least one of the differential cages is surrounded by a bell-shaped oil guide cap that is axially open on both sides and that has channels which are formed on its inner peripheral surface facing the at least one differential cage and which can guide oil in an axial direction within the oil guide cap in an intermediate space between the oil guide cap and the corresponding at least one differential cage.

11. The electrically operable axle drive train according to claim 10, wherein oil entering from one end of the oil guide cap via channel openings formed there by the oil guide cap can be guided into the differential cage surrounded by the oil guide cap with the aid of the channels.

12. The electrically operable axle drive train according to claim 10, wherein the at least one differential cage is rotatably mounted at one end via a tapered roller bearing relative to a connection structure of the transmission housing, wherein in rotary operation of the bevel gear differential the oil is introduced in the axial direction into the channel openings of the oil guide cap by the conveying effect generated by the rotation of the tapered roller bearing.

13. The electrically operable axle drive train according to claim 10, wherein the oil guide cap is connected for conjoint rotation to at least one of the differential cages at a connecting region with the at least one differential cage surrounded by the oil guide cap.

14. The electrically operable axle drive train according to claim 10, wherein the connecting region also comprises a connection for conjoint rotation of the two differential cages to one another.

15. The electrically operable axle drive train according to claim 10, wherein the oil guide cap is designed as a plastic injection-molded part.

16. The electrically operable axle drive train according to claim 10, wherein the channel openings widen the channels in a funnel-like manner in a circumferential direction.

17. The electrically operable axle drive train according to claim 10, wherein the channels of the oil guide cap are designed in a trough-like manner and have two axially extending and circumferentially opposite walls and an inner peripheral surface facing an axis of rotation for guiding the oil.

18. The electrically operable axle drive train according to claim 10, wherein the channels are delimited by an outer peripheral surface of the at least one differential cage surrounded by the oil guide cap.
